(19) United States
(12) Patent Application Publication
(10) Pub. No.: US 2004/0104671 A1
(43) Pub. Date: Jun. 3, 2004

(54) Electroluminescence light emitting device and method for manufacturing the same

(75) Inventors: Kimitaka Watanabe, Tokyo (JP); Hiroyuki Yamanaka, Higashikatsushika-gun (JP); Kazuyuki Yokota, Okaya-shi (JP); Masahiro Tamura, Suwa-shi (JP); Kiyonori Koike, Suwa-shi (JP); Shinsaku Fukuda, Komaki-shi (JP)

Correspondence Address: STAAS & HALSEY LLP, SUITE 700, 1201 NEW YORK AVENUE, N.W., WASHINGTON, DC, 20005, US

(73) Assignee: TOMY COMPANY, LTD., Tokyo (JP)

(21) Appl. No.: 10/651,210

(22) Filed: Aug. 29, 2003

(30) Foreign Application Priority Data
Aug. 30, 2002 (JP) PAT. 2002-254617
Apr. 25, 2003 (JP) PAT.2003-122723

(51) Int. Cl. H05B 33/00

(52) U.S. Cl. 313/506

(57) ABSTRACT

An electroluminescence light emitting device having: an electroluminescence light-emitting layer containing electroluminescence light-emitting elements therein; an electrode section having first and second electrodes which are disposed on one surface side of the electroluminescence light-emitting layer and have a predetermined pattern in which the first and second electrodes are electrically separated from each other with a spacing region; a top coating layer, which is disposed on the other surface side of the electroluminescence light-emitting layer, and on a front surface of which an electrically conductive material is attachable to form an alternating current electric field in the electroluminescence light-emitting layer by an alternating current power supply voltage applied between the first and second electrodes, the top coating layer having a compound additive containing dielectric; and a waterproof layer which is provided between the electrode section and the electroluminescence light-emitting layer.

### BACKGROUND OF THE INVENTION

1. Field of the Invention

The present invention relates to an electroluminescence light emitting device and method for manufacturing the same.

2. Description of Related Art

An electroluminescence, hereinafter, which may be referred to EL simply, material is known as one of light emitting materials. Various types of EL light emitting sheets have been developed and put to practical use. The EL light emitting sheet is generally formed by laminating a first electrode, a light-emitting layer, an insulating layer, i.e., a light reflecting layer, a second electrode and a protective layer (top coating layer) in order. Generally, by applying an alternating voltage (AC voltage) between the fist electrode and the second electrode, a fluorescent material in the light-emitting layer emits light.

As another type of EL light emitting sheet, one having peculiar operation and effects is known (see, for example, Patent Document 1: Japanese Patent Laid-Open Publication No. Hei 8-153582). The EL light emitting sheet is formed by laminating an electrode section, an insulating layer and a light-emitting layer in order. The electrode section includes a plurality of electrode pairs each of which have a first electrode and a second electrode, which are formed like a comb. Then, an electrically conductive material in arbitrary shape is formed on the light-emitting layer as a film and the film is dried to be formed as a display electrode. Thereby, the parts in the light-emitting layer on which the display electrode is formed as a film emit light. In the EL light emitting sheet, a display electrode having a shape corresponding to the taste of a user can be formed, and then a desired light emission shape can be obtained.

However, in the EL light emitting sheet disclosed in Patent Document 1, there is a problem in increasing luminance. To increase the luminance, it is required to increase the capacity of a converter or an inverter that converts direct current into alternating current in a type of using a direct current power supply for driving.

### SUMMARY OF THE INVENTION

The present invention has been developed in view of the above-described circumstances.

An object of the invention is to provide an EL light emitting device which can increase the luminance by a structure of EL light emitting sheet.

In accordance with a first aspect of the present invention, an electroluminescence light emitting device comprises:

an electroluminescence light-emitting layer containing electroluminescence light-emitting elements therein;

an electrode section comprising first and second electrodes which are disposed on one surface side of the electroluminescence light-emitting layer and have a predetermined pattern in which the first and second electrodes are electrically separated from each other with a spacing region;

a top coating layer, which is disposed on the other surface side of the electroluminescence light-emitting layer, and on a front surface of which an electrically conductive material is attachable to form an alternating current electric field in the electroluminescence light-emitting layer by an alternating current power supply voltage applied between the first and second electrodes, the top coating layer comprising a compound additive containing dielectric; and

a waterproof layer which is provided between the electrode section and the electroluminescence light-emitting layer.

According to the electroluminescence light emitting device, since top coating layer contains the compound additive containing dielectric, an electric field can be easily formed in the top coating layer when an alternating voltage (AC voltage) is applied between the first and second electrodes. Thus, it is possible to increase the luminance in the EL light emitting device.

Preferably, in the electroluminescence light emitting device, the electroluminescence light-emitting layer contains a compound additive containing dielectric.

According to the electroluminescence light emitting device, since the top coating layer and the EL light-emitting layer contain the compound additive containing the dielectric, an electric field can be easily formed in the top coating layer and the EL light-emitting layer when an alternating voltage (AC voltage) is applied between the first and second electrodes. Thus, it is possible to increase the luminance in the EL light emitting device.

Preferably, in the electroluminescence light emitting device, the electroluminescence light emitting layer is formed with using ink which contains the electroluminescence light-emitting elements and a fluorocarbon resin by a silkscreen printing.

Preferably, in the electroluminescence light emitting device, a light-reflecting layer is provided between the electrode section and the electroluminescence light-emitting layer.

According to the electroluminescence light emitting device, since the light-reflecting layer is provided between the electrode section and the EL light-emitting layer, the light from the EL light-emitting layer does not disperse and is effectively concentrated on the surface (the side to be seen).

Preferably, in the electroluminescence light emitting device, the light-reflecting layer is formed with using ink which contains a barium titanate and a fluorocarbon resin by the silkscreen printing.

Preferably, in the electroluminescence light emitting device, the compound additive containing the dielectric is a silicon-based compound.

For example, preferably, a silicon-based coupling agent (silane coupling agent) is used as the silicon-based compound.

According to the electroluminescence light emitting sheet using the silicon-based coupling agent, dielectric constant is improved, and at the same time, adhesiveness to other resin film is improved because a polymer film of silicon is formed.

Preferably, in the electroluminescence light emitting device, the silicon-based coupling agent is added 0.05-5.0% by weight of a solution which is made by diluting a material for forming a layer with a solvent.

In the specification, the ratio of each component of compositions is indicated in mass %.

According to the electroluminescence light emitting device, the luminance increases in comparison with an electroluminescence light emitting device in which the compound additive containing dielectric such as the silicon-based coupling agent is not added.

Preferably, in the electroluminescence light emitting device, the waterproof layer is formed with using polyester-based ink by the silkscreen printing.

According to the electroluminescence light emitting device, since the polyester-based ink is used to form the waterproof layer, the adhesiveness between the layers is increased in comparison with the waterproof layer formed by using other ink.

Preferably, the top coating layer is formed with using ink which contains an urethane-based ink and a curing agent by the silkscreen printing.

Preferably, the urethane-based ink and the curing agent are mixed in a 7:8 ratio.

The urethane-based ink and the curing agent may be mixed in a 4:3 ratio.

In accordance with a second aspect of the present invention, a method for manufacturing an electroluminescence light emitting device comprises: an electroluminescence light-emitting layer containing electroluminescence light-emitting elements therein; an electrode section comprising first and second electrodes which are disposed on one surface side of the electroluminescence light-emitting layer and have a predetermined pattern in which the first and second electrodes are electrically separated from each other with a spacing region; a top coating layer, which is disposed on the other surface side of the electroluminescence light-emitting layer, and on a front surface of which an electrically conductive material is attachable to form an alternating current electric field in the electroluminescence light-emitting layer by an alternating current power supply voltage applied between the first and second electrodes; and a waterproof layer which is provided between the electrode section and the electroluminescence light-emitting layer, the method comprises the steps of:

adding a compound additive containing dielectric in the top coating layer; and

forming the waterproof layer with using polyester-based ink by the silkscreen printing.

According to the method for manufacturing the electroluminescence light emitting device, since the compound additive containing dielectric is added in the top coating layer, an electric field can be easily formed in the top coating layer when an alternating voltage (AC voltage) is applied between the first and second electrodes. Thus, it is possible to increase the luminance in the EL light emitting device.

In addition, according to the method for manufacturing the electroluminescence light emitting device, since the polyester-based ink is used to form the waterproof layer, the adhesiveness between the layers is increased in comparison with the waterproof layer formed by using other ink.

Preferably, the method for manufacturing the electroluminescence light emitting device further comprises a step of adding a compound additive containing dielectric in the electroluminescence light-emitting layer.

Preferably, the method for manufacturing the electroluminescence light emitting device further comprises a step of forming the electroluminescence light emitting layer with using ink which contains the electroluminescence light-emitting elements and a fluorocarbon resin by the silkscreen printing.

Preferably, the method for manufacturing the electroluminescence light emitting device further comprises steps of forming a light-reflecting layer with using ink which contains a barium titanate and a fluorocarbon resin by the silkscreen printing, and providing the light-reflecting layer under the electroluminescence light-emitting layer.

Preferably, the method for manufacturing the electroluminescence light emitting device further comprises a step of forming the top coating layer with using ink which contains an urethane-based ink and a curing agent by the silkscreen printing.

Preferably, the method for manufacturing the electroluminescence light emitting device further comprises a step of adding a hardening accelerator for forming the top coating layer.

According to the method for manufacturing the electroluminescence light emitting device, the luminescence can be improved more.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a partially enlarged sectional view of a main part of an EL light emitting sheet;

FIGS. 2A and 2B are schematic plan views showing a part of an electrode layer;

FIG. 3 is a perspective view of the external appearance of a drawing board;

FIGS. 4A and 4B are plan views showing an example of the external shape of the electrode pattern of the EL light emitting sheet built in the drawing board;

FIG. 5 is a functional block diagram of the drawing board;

FIG. 6 is a plan view showing the external shape of the electrode pattern according to variation 7 of the EL light emitting sheet;

FIGS. 7A, 7B and 7C show the electrode sections (electrode layers) according to variation 8 of the EL light emitting sheet schematically;

FIGS. 8A and 8B are plan views of a signboard according to variation 1 of the EL light emitting device; and

FIG. 9 is a control block diagram for the signboard according to variation 1 of the EL light emitting device.

### DETAILED DESCRIPTION OF THE PREFERRED EMBODIMENTS

Hereinafter, the preferred embodiments of the present invention will be described in detail by reference to the attached drawings.

A. EL Light Emitting Sheet

1. Whole Configuration

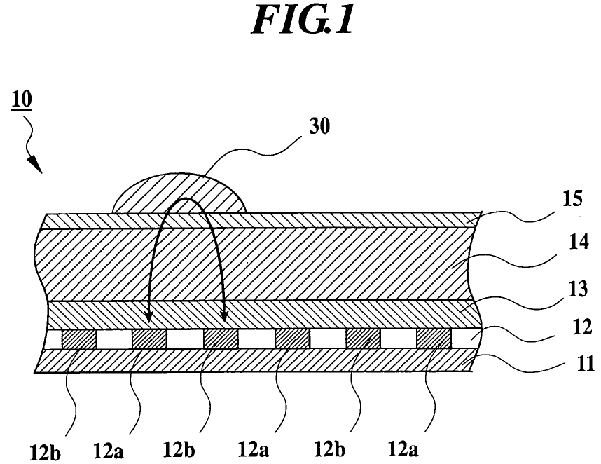

FIG. 1 is an enlarged sectional view of a main part of an EL light emitting sheet 10 to which the present invention is applied. In FIG. 1, the EL light emitting sheet 10 is formed by laminating a base layer 11, an electrode layer (electrode section) 12, a waterproof layer 13, a light-reflecting layer 16, an EL light-emitting layer 14 and a top coating layer 15 in this order. The waterproof layer 13, the light-reflecting layer 16, the EL light-emitting layer 14 and the top coating layer 15 are formed by the silkscreen printing or the like.

2. Detailed Configuration

(1) Base Layer 11

The base layer 11 is made of an insulating material such as polyethylene terephthalate (PET) or the like. The base layer 11 may be configured as a base film (substrate sheet). In this case, the base film is made of a transparent or opaque resin. As the resin in this case, for example, PET is used. The base layer 11 may be made of glass.

(2) Electrode Layer 12

The electrode layer 12 having a predetermined electrode pattern is formed by depositing a metal such as copper, aluminum or the like on the base layer 11, and thereafter by performing etching or the like to the deposited metal layer. Alternatively, the electrode layer 12 is formed by depositing, for example, a pasty silver paste including silver powder, a pasty copper paste including copper powder, another electrically conductive paste such as carbon, or the like on the base layer 11 in a predetermined pattern by the screen printing process, and thereafter by performing a heat drying process of the paste.

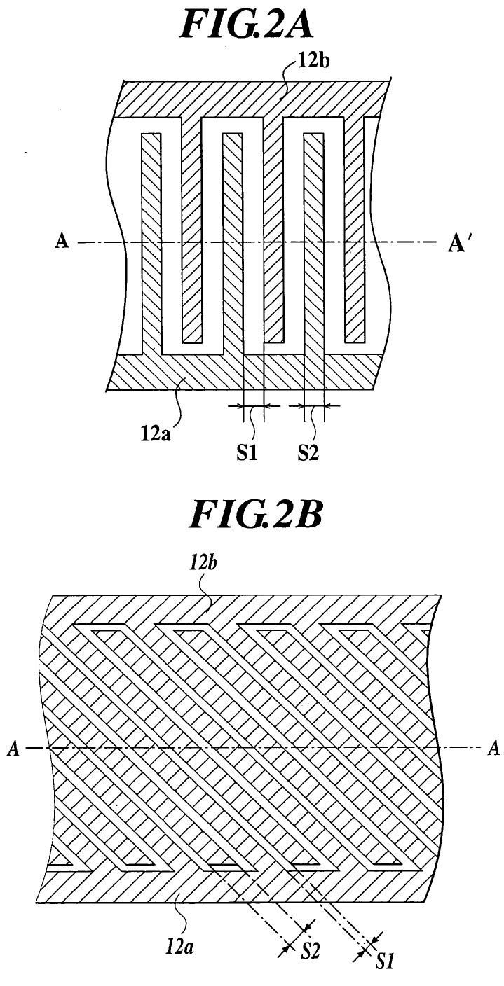

FIGS. 2A and 2B are schematic plan views showing a part of the electrode layer 12. The electrode layer 12 of FIG. 1 shows the cross section of the electrode layer 12, taken along the A-A′ line of FIGS. 2A and 2B. As shown in FIG. 2A, first electrodes 12a, 12a, . . . and second electrodes 12b, 12b, . . . are formed to have a comb-like pattern shape severally, and they are formed to be engaged with each other with a predetermined gap between their teeth with putting a spacing region between each tooth so that each tooth does not touch each other. Since each of first electrodes 12a, 12a, . . . is electrically connected with one another, each of them has the same electric potential. Since each of second electrodes 12b, 12b, . . . is also electrically connected with one another similarly, each of them has the same electric potential.

It is preferable to form the first electrodes 12a and the second electrodes 12b so that the spacing regions therebetween may substantially be the same per a unit area in a light emitting region.

When the EL light emitting sheet 10 is used for drawing a light emitting chart such as a character or a drawing and the like, it is preferable, as shown in FIG. 2B, to provide the EL light emitting sheet 10 with the extending direction of the comb-like pattern portions being inclined from the width direction of the EL light emitting sheet 10. That is, vertical and horizontal lines are frequently used in a character or a drawing and the like. Thus, if the extending direction of the comb-like pattern portions extends in the width or longitudinal direction of the electroluminescence light emitting sheet, the probability of AC electric field formation is lowered. In this case, it is preferable to incline the extending direction of the comb-like pattern portions at an angle in a range of 45±22.5 degrees with respect to the width direction.

The reason for inclining the extending direction of the comb-like pattern portions of the EL light emitting sheet 10 with respect to the width direction is to increase a probability of the AC electric field formation when the electrically conductive material forming a characters or drawings and the like is put on the surface of the light-emitting layer, and to reduce flecks of light emission.

That is, vertical and horizontal lines are frequently used in a character or a drawing and the like. The EL light emitting device with an increased probability of the AC electric field formation and less flecks of light emission is obtained by inclining the extending direction of the comb-like pattern portions of the EL light emitting sheet from the width direction portions of the EL light emitting sheet 10. In particular, the probability of the AC electric field formation increases significantly when the comb-like pattern portion extends being inclined at an angle in a range of 45±22.5 degrees with respect to the width direction.

The gap between the first electrode 12a and the second electrode 12b which are next to each other may be, for example, about 0.1-2.0 mm, and the width of the first electrode 12a and the second electrode 12b themselves may be, for example, about 0.1-5.0 mm, which are enough for light emission only. However, when taking into account the case of placing a chart for light emission, of a thin line which is approximately parallel to the extending direction of comb-shaped pattern electrode, or a dot-shaped chart for light emission, the gap between the first electrode 12a and the second electrode 12b which are next to each other is preferably about 0.2-0.3 mm, and the widths of the first electrode 12a and the second electrode 12b themselves are preferably about 0.2-0.5 mm.

The reason for the above-described definition of gap or width is as follows.

When the gap between the first electrode 12a and the second electrode 12b is less than 0.2 mm, there is a large possibility that a light emission (spontaneous emission) which is not negligible is created in also a region onto which no conductive material 30 is placed. When the gap is more than 0.3 mm, particularly, in a case of placing a chart of a thin line, flecks of light emission stand up. Under conditions, that is, EL sheet with a light emitting region of 140 mm×92 mm, starting voltage of 250V to 270V and current of 100 mA to 130 mA, luminance of emitted lights from two EL light emitting sheets which have gaps of 0.2 mm and 0.15 mm, respectively, were compared. As a result, the luminance of emitted lights from the EL light emitting sheet having the gap of 0.2 mm was 3±0.5 candela and that of 0.15 mm was 6±0.5 candela which was approximately twice that of 0.2 mm gap case. Therefore, it is considered that when assuming a regular use condition in an ordinary room as an industrial product, the luminance of emitted light, of 3±0.5 candela which is obtained by the gap of 0.2 mm is a lower limit.

On the other hand, when the width sizes of the first electrode 12a and the second electrode 12b themselves are less than 0.2 mm, there are problems that the luminance of emitted lights may be lowered and the productivity may deteriorate by bridge or disconnection, occurred in mass production. When the width sizes are more than 0.5 mm, there is a problem that in a case of placing a dot-shaped chart for light emission by using a pen for drawing a thin line, probability of AC electric field formation with another electrode is lowered because the thin chart may be within the width of one electrode. When the width sizes are not more than 0.5 mm, the probability of AC electric field formation with another electrode is increased because the probability of the placed dot-shaped chart being out of the one electrode is much larger than that of the chart being placed at the center of the one electrode.

Thus, it is possible to increase the probability of AC electric field formation, to restrain occurrence of flecks of light emission.

(3) Waterproof Layer (Undercoat Layer) 13

The waterproof layer 13 is a layer for protecting the electrode layer 12 and is made of a resin. As the resin, the following resins can be used. That is, they are, for example, a fluorocarbon resin such as a 4-fluorinated ethylene resin, fluororubber and the like; a silicon resin such as silicon rubber and the like. Another resin having a high sealing property such as an epoxy resin, an acrylic resin, a urethane resin, a polyester resin, an ethylene-vinyl acetate copolymer or the like, can also be used. These resins are cured by a method such as ultraviolet (UV) curing, infrared (IR) curing, two-liquid curing, heat curing and the like.

To give a specific example, when an ink composition containing polyester resin as a resin component, for example, a polyester-based ink EX-2211 Clear E01 (made by MINO Group Co., LTD.) is used as a material for forming a layer, the ink composition is diluted with a ketone-based solvent to be ink for the silkscreen printing. The ink is used to form the waterproof layer 13 by the silkscreen printing and dried.

(4) Light-Reflecting Layer (Dielectric Layer) 16

The light-reflecting layer 16 is arranged between the waterproof layer 13 and the EL light-emitting layer 14. The light-reflecting layer 16 adheres to the EL light-emitting layer 14. Preferably, the light-reflecting layer 16 has a thickness of about 10-30 μm, a withstanding voltage of about 200-300 V, and a dielectric constant of about 30-100, more preferably about 60-100.

The light-reflecting layer 16 is made by dispersing inorganic powder which is ferroelectric powder such as barium titanate or Rochelle salt, into a resin functioning as a bonding agent such as an acrylic resin or the like. Since the inorganic powder such as the ferroelectric powder is a pigment showing white, the light-reflecting layer 16 becomes white, and therefore the light-reflecting layer 16 exhibits the light-reflecting function effectively.

To give a specific example, the light-reflecting layer 16 comprises a barium titanate and a fluorocarbon resin that are diluted with a solvent to be ink for the silkscreen printing. The light-reflecting layer 16 is formed by the silkscreen printing and dried.

(5) EL Light-Emitting Layer 14

The EL light-emitting layer 14 is made of organic or inorganic EL light-emitting elements sealed with a sealing resin. The EL light-emitting elements are fixed with being dispersed in a transparent resin binder. As the resin binder, a resin having a high dielectric constant such as a polyester resin or the like may suitably be selected. It is preferable that a material for forming the EL light-emitting layer 14 contains a compound additive containing dielectric.

The EL light-emitting layer 14 may comprise the EL light-emitting elements and a fluorocarbon resin. In this case, the EL light-emitting elements and the fluorocarbon resin are diluted to be ink for the silkscreen printing. Further, a silicon-based coupling agent A• 187 (made by Nippon Unicar Co., Ltd.) of a silicon-based compound of 0.05-5.0%, preferably 0.3-0.5%, by weight of the mixed solution is added, and the EL light-emitting layer 14 is formed by the silkscreen printing and dried. The reason for the above-described definition of adding amount is as follows. When the adding amount is less than 0.05%, there is expected little effect on increasing the luminance. When the adding amount is over 5.0%, the luminance decreases.

In this case, it is preferable that the EL light-emitting layer 14 has a thickness of about 30-40 μm, a withstanding voltage of about 50-150 V, and a dielectric constant of about 10-30. The thickness of the EL light-emitting layer 14 is preferably one and a half times as large as the diameter of the EL light-emitting elements or more. With such a thickness, the surfaces of the EL light-emitting layer 14 is regarded as being smooth, and for example, their surface roughness is regarded as being 30 μm or less.

The EL light-emitting layer 14 configured as above emits the light of a predetermined luminescent color when an AC power supply voltage is applied between the first electrodes 12a and the second electrodes 12b.

(6) Top Coating Layer 15

The top coating layer 15 is stuck or fixed, closely to the EL light-emitting layer 14 to protect the EL light-emitting layer 14. The top coating layer 15 is laminated on the EL light-emitting layer 14 also for improving the smoothness of the EL light-emitting layer 14 and the removability of an electrically conductive material 30.

As the top coating layer 15, the following resins can be used. That is, they are, for example, a fluorocarbon resin such as a 4-fluorinated ethylene resin, fluororubber and the like; a silicon resin such as silicon rubber and the like; a polyester resin; an urethane resin and the like. It is preferable that a material for forming the top coating layer 15 contains a compound additive containing dielectric.

To give a specific example, a solution in which an ink composition containing an urethane resin as a resin component, for example, an urethane-based ink SG460 (made by SEIKO ADVANCE Ltd.) and an H Curing Agent (hard coating agent)(made by SEIKO ADVANCE Ltd.) are mixed in a 7:8 ratio is diluted to be ink for the silkscreen printing. A silicon-based coupling agent of a silicon-based compound of 0.05-5.0%, preferably 0.3-0.5%, by weight of the mixed solution is added, and the top coating layer 15 is formed by the silkscreen printing and dried. The reason for the above-described definition of adding amount is as follows. When the adding amount is less than 0.05%, there is expected little effect on increasing the luminance. When the adding amount is over 5.0%, the luminance decreases.

Since the main object of providing the top coating layer 15 is, as described above, to smooth the surface of the EL light-emitting layer 14 and to improve the removability of conductive material out of the surface thereof, the thickness of the top coating layer 15 is enough to be a degree which makes it possible to attain the object. On the other hand, it is suitable that the top coating layer 15 is as thin as possible. The reason for this is that the more the thickness is, the more the luminous intensity of the EL light emitting sheet 10 decreases. The thickness is practically preferable to be about 1-2 μm as the effective value. Hereupon, the “effective value” means the size of the thickness of the top coating layer 15 placed on the uppermost part of the EL light-emitting layer 14. It is sufficient for obtaining the thickness of about 1-2 μm as the effective value to-make the coating value of the thickness about 5-8 μm. Hereupon, the “coating value” means the thickness of the protection layer 15 when the coating is performed on a surface having no irregularities.

The top coating layer 15 may be formed by gluing a film-like or sheet-like member fixedly onto the EL light-emitting layer 14, or by placing a flexible material member thereto closely. For forming the top coating layer 15, a hardening accelerator is preferably added. For example, a CARE 101 (made by SEIKO ADVANCE Ltd.) may be used as the hardening accelerator. It is preferable to add the hardening accelerator of 2-3% (preferably 2%) by weight of, the ink composition and the curing agent. In choosing a hardening accelerator, it should be considered that the hardening accelerator has a high chemical affinity with a material of the top coating layer 15, little negative effects on the EL light-emitting layer 14 beneath the top coating layer 15, and a high hardening power.

(7) Electrically Conductive Material 30

As the electrically conductive material 30, the following known materials can be used. That is, the conductive material includes: a stick type painting material such as well-known ink, a pencil, a crayon, a pastel and the like; a sheet material having electrical conductivity (hereinafter referred to as a conductor sheet) and the like. As the stick type painting material such as the ink, the pencil, the crayon, the pastel and the like, ones including an organic or an inorganic coloring pigment may be used.

As the ink, one having the following properties is preferable. The properties are, for example, to have a surface resistance value equal to or less than 10⁶ Ω/□ in the state of being coated, to have optical transparency, and to include at least one kind of powder of the electrically conductive materials such as indium oxide, tin oxide, antimony, zinc oxide and the like, in a solvent. Further, as the ink, an electrically conductive polymer such as polyethylene dioxi thiophene and the like or a mixture of the electrically conductive polymer with the powder of the electrically conductive material may be used. In this case, it is possible to make the ink emit light for a long period until removal of the ink by wiping or the like. Moreover, the electrically conductive material 30 may be composed of water or a solvent, which have a high dielectric constant. In this case, the electrically conductive material 30 can easily be removed by drying it with a dryer, or by wiping it with a tissue, a piece of gauze, a sponge and the like.

In case of using the conductive sheet material, the conductive sheet material of a predetermined shape can be used, or the conductive sheet material can be cut to any shape for use.

3. Operation and Function

The electrically conductive material 30 is attached on the top coating layer 15 with a desired pattern. The attachment of the electrically conductive material 30 is performed by drawing with a brush, a pencil, a pastel, a crayon or the like, by performing printing with an ink jet printer or screen printing, by sticking an electrically conductive sheet, or the like. In the state, an AC power supply voltage is applied between the first electrode 12a and the second electrode 12b. The electrically conductive material 30 may be attached after the AC power supply voltage has previously been applied.

Then, by the attachment of the electrically conductive material 30, an AC electric field is formed in the EL light-emitting layer 14, and only the portion thereof just under the attached electrically conductive material 30 emits light locally. That is, since the EL light-emitting layer 14 has a high dielectric constant, a circuit composed of the first electrode 12a, the EL light-emitting layer 14, the electrically conductive material 30, the EL light-emitting layer 14, the second electrode 12b and the like is formed to create an AC electric field in the EL light-emitting layer 14. Then, the portion of the EL light-emitting layer just under the attachment part of the electrically conductive material 30 emits light. On the other hand, the intensity of the AC electric field at the rest portion of the EL light-emitting layer 14 just under the part where the electrically conductive material 30 is not attached is insufficient for the EL light-emitting layer 14 to emit light, and consequently the rest portion does not emit light. The thickness and the dielectric constant of the EL light-emitting layer 14 or the like are set in order that the portion of the EL light-emitting layer just under the attached electrically conductive material 30 may emit light selectively.

When the electrically conductive material 30 is liquid, there is a case where the electrically conductive material 30 permeates the EL light-emitting layer 14 to reach the waterproof layer 13 through a scratch, a pinhole or the like. However, the waterproof layer 13 prevents the further permeation of the electrically conductive material 30. Moreover, the waterproof layer 13 also prevents the permeation of moisture or humidity in the air.

4. Advantageous Effects

According to the present embodiment, an AC electric field is formed at the portion of the EL light-emitting layer 14 just under the attached electrically conductive material 30, and only the portion locally emits light. This thing indicates that, when the electrically conductive material 30 is attached to the top coating layer 15 in the same pattern as a desired pattern, a light emitting with the desired pattern can be obtained. Consequently, an EL light emitting sheet 10 with which a user can easily produce a desired light emitting pattern can be provided.

The electrode layer 12 of the EL light emitting sheet 10 is, as described above, formed by deposition of a metal. When it is intended to form the electrode layer 12 by, for example, deposition of aluminum, the thickness of the electrode layer 12 is preferably about 300-1,000 Å (10⁻¹⁰ m), more preferably about 400-800 Å (10⁻¹⁰ m). Since the electrode layer 12 is very thin and is formed by deposition of aluminum, if a user, for example, scratches the EL light emitting sheet with a cutter or strikes a nail, only a part of the electrode layer 12 contacting with the cutter or the nail, is melted almost simultaneously with the shortage. Consequently, the worst case where the whole of the electrode layer 12 is shorted is not generated, and the user does not receive electric shock.

The luminescent color of the EL light emitting sheet 10 can be changed by forming the EL light-emitting layer 14 by sealing the EL light-emitting elements with a coloring pigment mixed therein, by disposing a color filter between the EL light-emitting layer 14 and the top coating layer 15, by coloring the top coating layer 15, or by mixing a coloring pigment with the electrically conductive material 30.

B. EL Light Emitting Device

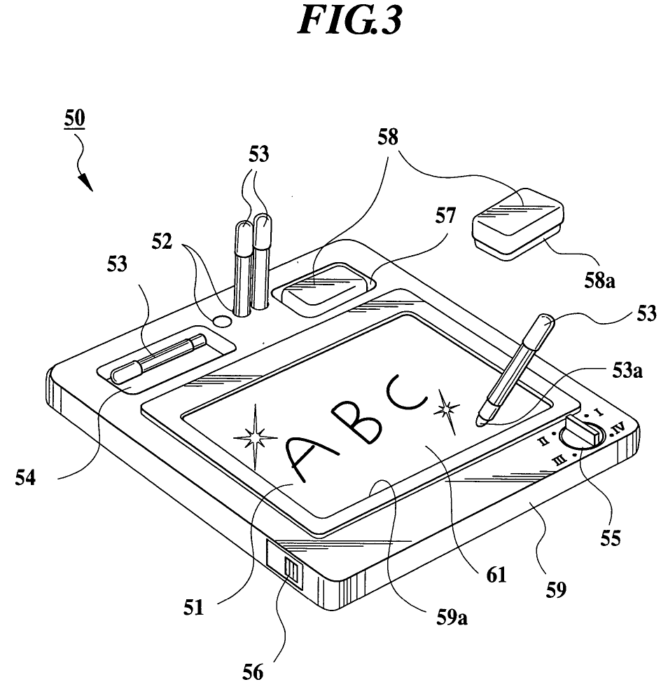

FIG. 3 is a perspective view showing the external appearance of a drawing board 50 as an example of an EL light emit-ti-ng device incorporating the above-mentioned EL light emitting sheet therein.

1. Whole Configuration

In the drawing board 50, a main body 59 with a shape like a board having a predetermined thickness holds the EL light emitting sheet 51 which is provided in the inside of the main body 59. The EL light emitting sheet 51 having the top coating layer 15 on the top surface thereof is exposed from an opening 59a. The drawing board 50 is configured to be provided with a highlight pen 53 having a pen point 53a made of an impregnating material impregnating the electrically conductive material 30 using electrically conductive ink which includes a fluorescent material, holders 52 for holding the highlight pens 53 in the state of standing up, a tray 54 having a shape of a recess capable of holding the highlight pens 53 in the state of lying on their sides in the inside of the tray 54, a removal member 58 carrying a sponge 58a which is superior in water absorbing property, for removing the electrically conductive member 30 from the top surface of the EL light emitting sheet 51, a tray 57 for holding the removal member 58 to allow the removal member to be taken out thereof, a change-over switch 55 for switching the light-emitting modes, and a power supply switch 56.

2. How to Use

A user may take a pen 53 out of the tray 54, and may draw an arbitrary light emitting chart by applying the electrically conductive material 30 on a drawing screen 61, namely the top surface part of the top coating layer 15 exposed from the opening 59a. In FIG. 3, a word “ABC” is drawn. When the power supply switch 56 is turned on, a closed circuit is formed with the electrically conductive material 30, the electrodes 12a, 12b, and the like. As a result, the EL light-emitting layer 14 emits light, and the emitted light is transmitted through the electrically conductive material 30 to be radiated. That is, since the lower parts where the pen 53 has drawn emit light, the drawing acts as if the characters “A”, “B” and “C” themselves were emitting light.

3. Detailed Configuration

(1) Electrode Pattern

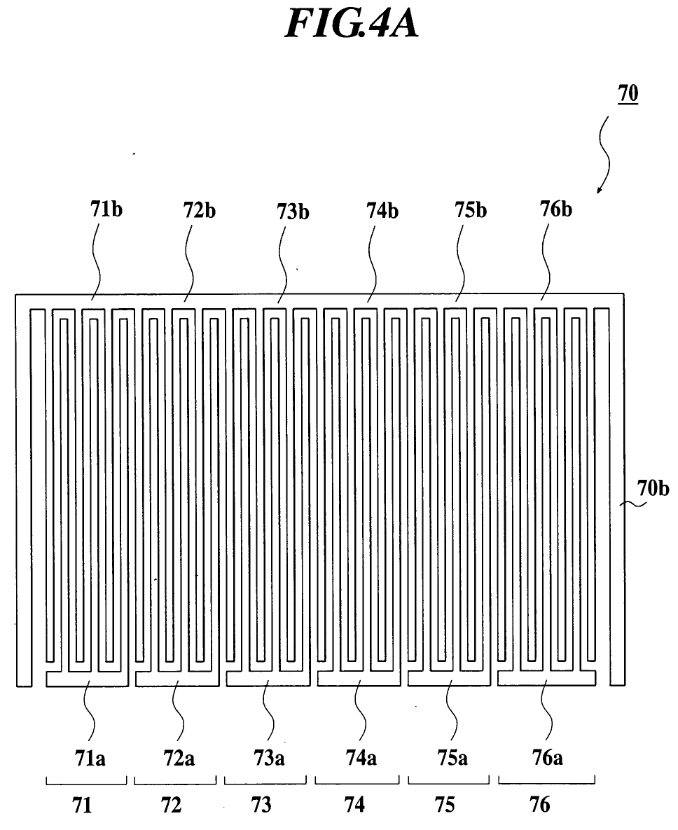

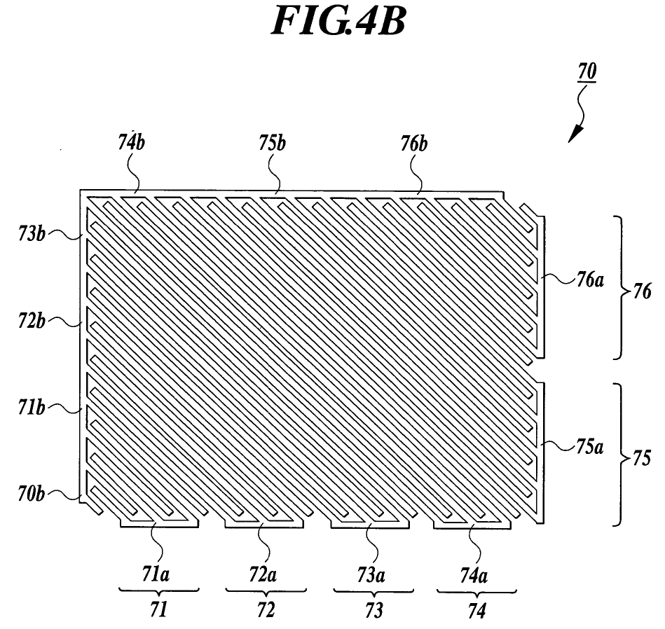

Next, an electrode pattern of the EL light emitting sheet 51 built in the drawing board 50 will be described. FIG. 4A is a plan view showing the outline of the electrode pattern 70 of the EL light emitting sheet 51 built in the drawing board 50. The electrode pattern 70 means the shape of the electrode layer 12 formed on the base layer 11. In the figure, an electrode 71a and an electrode 71b constitute an electrode pair 71, and the electrode 71a and 71b have substantially the same figures as the comb-like pattern shapes of the electrodes 12a and 12b in FIG. 2A. The electrode pattern 70 includes six electrode pairs 71-76 having substantially the same configuration as the electrode pair 71 severally. The electrode pairs 71-76 are aligned. The upper end parts of the electrodes 71b-76b of respective electrode pairs 71-76 in the figure are connected with one another to form an electrode line (earth line) 70b which is connected to the ground. On the other hand, the electrodes 71a-76a are not connected with one another.

When a predetermined voltage (AC voltage) is applied to each of the electrodes 71a-76a, each of the electrode pairs 71-76 takes the state capable of forming a closed circuit. To put it more concretely, when the electrically conductive material 30 is coated on the drawing screen 61 while the voltage is applied to all of the electrodes 71a-76a, a closed circuit is formed between the electrically conductive material 30 and an electrode pair at any place on the drawing screen 61 through-the EL light-emitting layer 14 and the like. However, when the voltage is applied to only a part of the electrodes 71a-76a, only the part of the electrode pair corresponding to the electrode to which the voltage is applied can form a closed circuit (the sate may be referred to as a “closed circuit formation possible state”, and a state other than the above-mentioned state may be referred to as a “closed circuit formation impossible state” in the present specification).

When the EL light emitting sheet 51 is used for drawing a light emitting chart such as a character, a drawing and the like, it is preferable to dispose the EL light emitting sheet 51 with the extending direction of the comb-like pattern portions inclined with respect to the width direction of the EL light emitting sheet 51 as shown in FIG. 4B. Further, it is more preferable to incline the extending direction of the comb-like pattern portions at an angle in a range of 45±22.5 degrees with respect to the width direction of the EL light emitting sheet 51. In FIG. 4B, the reference numerals 71-76 denote an electrode pair, and the reference numerals 71a-76a and 71b-76b denote an electrode, like FIG. 4A.

In a case of putting on (placing, adhering, applying or the like) a conductive chart for light emission, of a thin line which is approximately parallel to the extending direction of comb-shaped pattern electrode, or in a case of putting on a dot-shaped conductive chart for light emission, the gap S1 of about 0.2-0.3 mm between the first and second electrode, which are next to each other, is preferable, and the widths S2 of the first and second electrodes themselves, of about 0.2-0.5 mm, are preferable from the same reason described above.

(2) Internal Circuits

FIG. 5 is a functional block diagram of the drawing board 50. In the figure, the drawing board 50 is provided with a control unit 110 composed of a central processing unit (CPU), a random access memory (RAM), a read only memory (ROM) and the like, a battery 130 composed of dry cells, and a voltage application unit 120. The voltage application unit 120 includes an inverter circuit 121 for converting a direct-current (DC) voltage supplied from the battery 130 to an AC voltage, and a booster circuit (not shown). The voltage application unit 120 applies an effective AC voltage of about 100-300 V between the earth line 70b of the electrode pattern 70 and each of the electrode pair 71-76 according to a control signal input from the control unit 110.

The control unit 110 stores programs instructing the procedures of applying the voltage to the electrode pattern 70 into the ROM at every light emitting mode. The control unit 110 reads a corresponding program according to a mode selection signal which is input from the change-over switch 55, and outputs a control signal to the voltage application unit 120.

Then, various light emitting modes can be realized by controlling the voltage application to the electrode pairs 71-76. In the drawing board 50, an entirely light-emitting mode (mode I), an entirely blinking mode (mode II), a sequentially light-emitting mode (mode III) and a wavy light-emitting mode (mode IV) are executed by the switching of the change-over switch 55.

(3) Light-Emitting Modes

(a) Entirely Light-Emitting Mode

The entirely light-emitting mode is a mode in which an voltage is applied to all of the electrode pair 71-76 simultaneously and continuously. In other words, the mode is one in which all of the electrode pairs 71-76 are in the closed circuit formation possible state. If the electrically conductive material 30 is coated on all over the drawing region 61, the whole surface of the drawing region 61 continuously emits light.

(b) Entirely Blinking Mode

The entirely blinking mode is a mode in which a voltage is applied to all of the electrode pairs 71-76 simultaneously and intermittently. In other words, the mode is one in which all of the electrode pairs 71-76 simultaneously take the closed circuit formation possible state or-the closed circuit formation impossible state alternately at predetermined time intervals. If the electrically conductive material 30 is coated on all over the drawing region 61, the whole surface of the drawing region 61 intermittently emits light.

(c) Sequentially Light-Emitting Mode

The sequentially light-emitting mode is a mode in which a voltage is accumulatively applied to the electrode pairs 71-76 in the order of their arrangement. In other words, the mode is one in which the electrode pairs 71-76 which have been in the closed circuit formation impossible state sequentially become the closed circuit formation possible state at predetermined time intervals. If the electrically conductive material 30 is coated on all over the drawing region 61, an area part corresponding to each of the six electrode pairs sequentially emits light (since there are six electrode pairs), and the area emitting light gradually increases. After all of the electrode pairs have become the closed circuit formation possible state, the application of the voltage to all of the electrode pairs 71-76 is stopped after a predetermined time to make all of the electrode pairs 71-76 be in the closed circuit formation impossible state. Thereby, the electrode pairs 71-76 return to the initial state, and the execution of the sequential light-emitting is repeated.

(d) Wavy Light-Emitting Mode

The wavy light-emitting mode is a mode in which a voltage is intermittently applied to the electrode pairs 71-76 in the order of their arrangement. In other words, the mode is one in which each of the electrode pairs 71-76 repeatedly transits the closed circuit formation possible state and the closed circuit formation impossible state with a predetermined time lag. If the electrically conductive material 30 is coated on all over the drawing region 61, each area part corresponding to each of the six electrode pairs sequentially emits light and does not emit light, and consequently the parts emitting light operates to appear as if they were moving while waving.

4. Advantageous Effects

As described above, in the drawing board 50, it is possible to draw a light emitting chart by applying the electrically conductive material 30 easily with the highlight pen 53. Moreover, it is also possible to remove the coated electrically conductive material 30 easily. Consequently, the repeating drawing of charts for light emitting can easily be realized.

Furthermore, a plurality of electrode pairs are formed in the EL light emitting sheet, and the control unit 110 controls the execution of the voltage application to each electrode pair. Thereby, light-emitting modes for light emitting charts can variously be changed, which makes it possible to realize interesting light emission together with the aid of the variation of the places where the electrically conductive material 30 are coated.

It is needless to say that the EL light emitting device may be applied to other toys. In that case, the toys are not limited to the ones aiming to draw the light emitting charts like the EL light emitting display toys (for example, the drawing board 50), but the toys may be ones incorporating the EL light emitting device as a part of them.

C. Variations of EL Light Emitting Sheet

1. Variation 1 of EL Light Emitting Sheet

Although in the EL light emitting sheet 10, 51, the waterproof layer 13 is arranged between the electrode layer 12 and the light-reflecting layer 16, the waterproof layer 13 is arranged between the light-reflecting layer 16 and the EL light-emitting layer 14 in variation 1. Other structure is as same as the EL light emitting sheet 10 or 51.

2. Variation 2 of EL Light Emitting Sheet

In variation 2, the EL light emitting sheet has a structure in which the base layer 11, one of first and second electrodes 12a and 12b, the waterproof layer 13, the other of first and second electrodes 12a and 12b, the light-reflecting layer 16, the EL light-emitting layer 14 and the top coating layer 15 are laminated in this order. Other structure is as same as the EL light emitting sheet 10 or 51. The light-reflecting layer 16 may be omitted.

3. Variation 3 of EL Light Emitting Sheet

In variation 3, the EL light emitting sheet has a structure in which the base layer 11, one of first and second electrodes 12a and 12b, the light-reflecting layer 16, the waterproof layer 13, the other of first and second electrodes 12a and 12b, the EL light-emitting layer 14 and the top coating layer 15 are laminated in this order. Other structure is as same as the EL light emitting sheet 10 or 51.

4. Variation 4 of EL Light Emitting Sheet

Variation 4 is one that a further change is given to the EL light emitting sheet 10 or 51 according to the embodiment, or one of variations 1-3. The EL light emitting sheet according to the variation 4 has a structure in which the EL light-emitting layer 14 and/or the light reflecting layer 16 has a permeation prevention function to water or the like, instead of or in addition to the waterproof layer 13. Other structure is as same as the EL light emitting sheet 10 or 51.

The EL light-emitting layer 14 with the permeation prevention function is composed of, for example, an organic or inorganic EL light-emitting elements being phosphor particles or phosphorescent particles, and a transparent resin binder for fixing the EL light-emitting elements in the state of being dispersed. The variation 4 uses a resin having a waterproof property or a moisture-proof property as the resin binder. The following resins are used. That is, the resins are, for example, for example, a fluorocarbon resin such as a 4-fluorinated ethylene resin, fluororubber and the like; a silicon resin such as silicon rubber and the like; the other epoxy resins; an acrylic resin; a urethane resin; a polyester resin; and a resin having a high sealing property such as an ethylene-vinyl acetate copolymer and the like. These resins are cured by a method such as the UV curing, the IR curing, the two-liquid curing, the heat curing and the like.

It is preferable that a material for forming the EL light-emitting layer 14 contains a compound additive containing dielectric.

Further, as the resins constituting the light-reflecting layer 16 having the permeation prevention function, the following resins having the waterproof property or the moisture-proof property are used. The resins are, for example, a fluorocarbon resin such as a 4-fluorinated ethylene resin, fluororubber and the like; a silicon resin such as silicon rubber and the like; the other epoxy resins; an acrylic resin; a urethane resin; a polyester resin; and a resin having a high sealing property such as an ethylene-vinyl acetate copolymer and the like. These resins are cured by a method such as the UV curing, the IR curing, the two-liquid curing, the heat curing and the like.

According to the variation 4, since the light-reflecting layer 16 prevents the permeation of water and the like, the generation of electrolysis between the first electrode 12a and the second electrode 12b can be prevented. Moreover, the snapping (damage) of a wire caused by the oxidation of the first electrode 12a and the second electrode 12b can be prevented.

5. Variation 5 of EL Light Emitting Sheet

In the variation 5, the first electrode 12a and the second electrode 12b are formed on the back surface of a base film or a sheet of glass (base layer 11) which have a permeation prevention function. As the base film in this case, one made of, for example, polyethylene terephthalate (PET) is used.

According to the variation 5, since the base film or the sheet of glass prevents the permeation of water and the like from the front side, the generation of electrolysis between the first electrode 12a and the second electrode 12b can be prevented. Moreover, the snapping (damage) of a wire caused by the oxidation of the first electrode 12a and the second electrode 12b can be prevented.

The configuration is used in the case where the EL light emitting sheet is incorporated in a case body or the like. In the case where the EL light emitting sheet is incorporated in the case body as described above, the back surface side is generally sealed not to be exposed. Consequently, it is needless to consider the attachment of water and the like from the back surface side. If necessary, it is enough to coat the exposing electrodes with a resin having the permeation prevention function, or to perform the alumite processing of the exposing electrodes.

Although the first electrode 12a and the second electrode 12b are provided on the back surface of the substrate sheet in the variation 5, the first electrode 12a and the second electrode 12b may be provided with putting the substrate sheet between them.

6. Variation 6 of EL Light Emitting Sheet

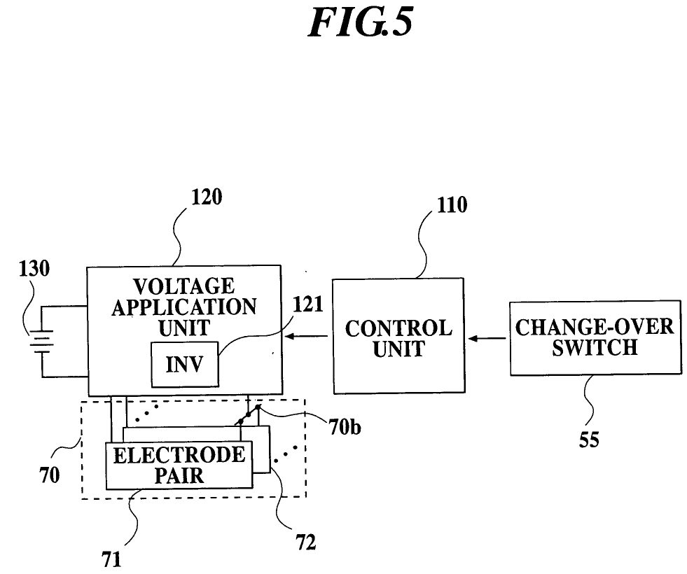

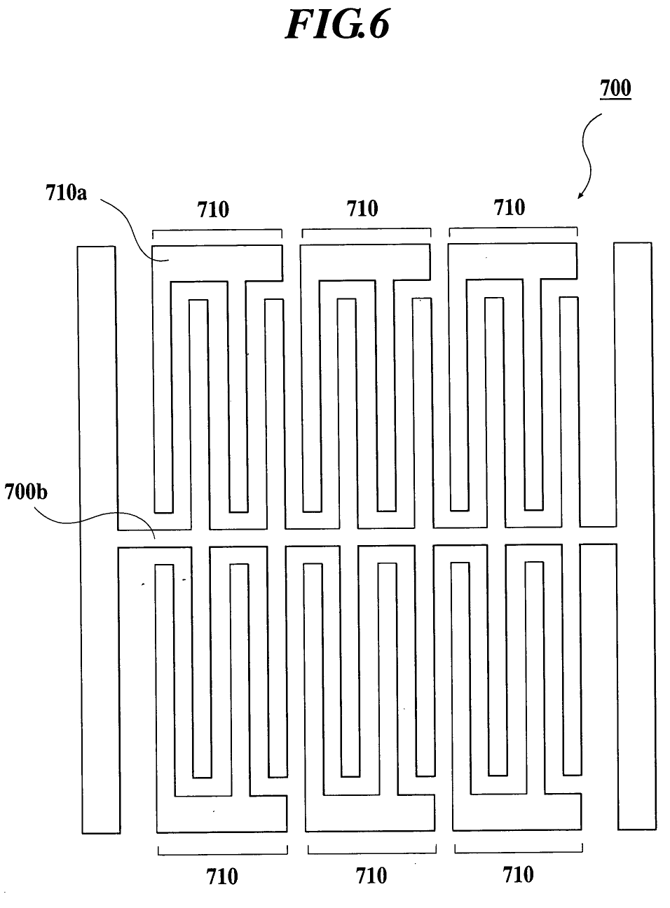

FIG. 6 shows the outline of the electrode pattern of the variation 6. In the figure, the electrode pattern 700 is a two dimensional arrangement composed of six comb-shaped electrode pairs 710 in all, three of which are arranged at the upper row in the right and left direction in the figure, and the other three of which are arranged at the lower row in the right and left direction in the figure. Moreover, the electrode pairs 710 are arranged so that the electrodes of each electrode pair are engaged in the upper and lower direction in the figure. Then, the electrode end of the earth side electrode of each electrode pair is integrally formed as an earth line 700b between the upper row electrode pairs and the lower electrode pairs of the two rows. By means of the electrode pattern 700, a wide variety of light emitting patterns can be formed with the six electrode pairs in all.

Furthermore, owing to the arrangement of the earth line 700b between the upper row electrode pairs and the lower row electrode pairs of the two rows, the gap of the upper row electrode pairs and the lower row electrode pairs can be narrowed. That is, if a displacement side electrode 710a is arranged between the upper row electrode pairs and the lower row electrode pairs of the two rows, it is impossible to connect the upper row electrode 710a and the lower row electrode 710a cannot connected with each other, and then it is necessary to arrange them with a predetermined space between them. Consequently, the gap between the upper row and the lower row of the two rows becomes wide, and the gap becomes clear in some light emission patterns. On the other hand, if the earth line 700b is arranged at the center, it becomes possible to remove, or at least to reduce, the defect as above.

When the EL light emitting sheet is used for drawing a light emitting chart such as a character, a drawing and the like, it is preferable to dispose the EL light emitting sheet 51 with the extending direction of the comb-like pattern portions inclined with respect to the width direction of the EL light emitting sheet. Further, it is more preferable to incline the extending direction of the comb-like pattern portions at an angle in a range of 45±22.5 degrees with respect to the width direction of the EL light emitting sheet.

In a case of putting on (placing, adhering, applying or the like) a conductive chart for light emission, of a thin line which is approximately parallel to the extending direction of comb-shaped pattern electrode, or in a case of putting on a dot-shaped conductive chart for light emission, the gap of about 0.2-0.3 mm between the first and second electrode, which are next to each other, is preferable, and the widths of the first and second electrodes themselves, of about 0.2-0.5 mm, are preferable from the same reason described above.

7. Variation 7 of EL Light Emitting Sheet

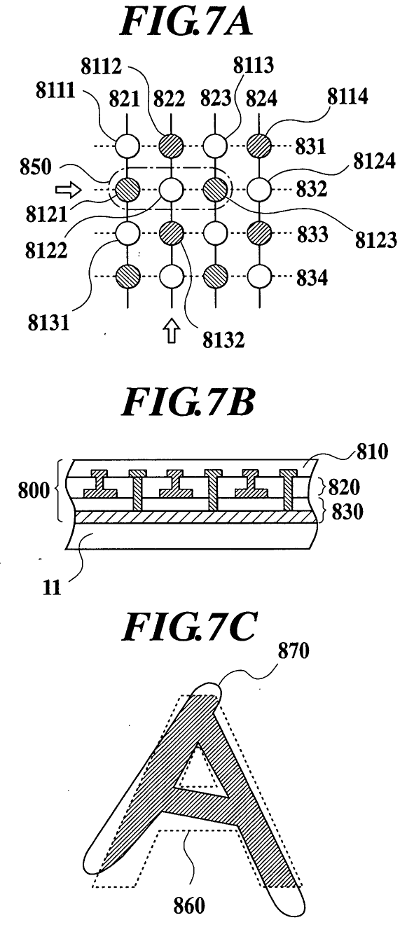

FIGS. 7A, 7B and 7C show the outline of the electrode section of the variation 7. The variation 7 is provided with an electrode section (electrode layer) 800 using a printed circuit board. FIG. 7A is a plan view of an enlarged substantial part of the electrode section 800 viewed from the side of an EL light-emitting layer. FIG. 7B is a sectional view of the electrode section 800. The electrode section 800 has a three-layer configuration composed of a first electric potential line layer 830, a second electric potential line layer 820 and an electrode terminal layer 810. In the first electric potential line layer 830, a plurality of first electric potential lines 831, 832, 833 and 834 extending in the right and left direction in FIG. 7A are formed in parallel to one another. In the second electric potential line layer 820, a plurality of second electric potential lines 821, 822, 823 and 824 extending in the upper and lower direction in FIG. 7A are formed in parallel to one another. In the electrode terminal layer 810, the terminals via holes, which are connected any one of the first electric potential lines 831-834 or the second electric potential lines 821-824, are two dimensionally arranged. In FIG. 7A, black circles indicate the terminals via holes connected to the first electric potential lines, and white circles indicate the terminals via holes connected to the second electric potential lines. The white circles and the black circles are alternately arranged in staggered fashion. For example, the terminals connected to the first electric potential line 831 are terminals 8112 and 8114, and the terminals connected to the second electric potential line 821 are terminals 8111 and 8131.

A first voltage is applied to the first electric potential lines 831-834, and a second voltage is applied to the second electric potential lines 821-824. The lines to which the voltages are applied are selected and controlled by the control unit. To put it concretely, for example, the first electric potential line 832 is selected as the line to which the first voltage is applied, and the second electric potential line 822 is selected as the line to which the second voltage is applied. In this case, the terminals 8121 and 8123 take the electric potential of the first voltage applied to the first electric potential line 832, and the terminal 8122 and the like take the electric potential of the second voltage applied to the second electric potential line 822. Consequently, owing to the potential difference between the terminal 8121 and the terminal 8122, and the potential difference between the terminal 8122 and the terminal 8123, a region 850 enclosed by an alternate long and short dash line in FIG. 7A becomes closed circuit formation possible state.

By forming an EL light emitting sheet by the use of the electrode section 800, and by performing selection control of the electric potential lines to which predetermined voltages (AC voltages) are applied, regions in the closed circuit formation possible state or in the closed circuit formation impossible state can arbitrarily be controlled. For example, in a case that the electrically conductive material 30 is coated all over the drawing screen, it is possible to emit light, i.e., to change the light emission form, so that arbitrary characters or charts are raised up. Moreover, it is also possible to realize various light emission patterns such as enlargement of the area of parts emitting light in concentric circles.

Further, a using method which is shown in FIG. 7C can also be carried out. FIG. 7C is a plan view of a part of a drawing screen. The figure shows a supposed case where a user is practicing how to write a character “A”. A region 860 enclosed by broken lines is in the closed circuit formation possible state, and a region 870 enclosed by solid lines is a part of the electrically conductive material 30 coated with a highlight pen as a light emitting chart. In this case, the hatched portion where the region 860 and the region 870 are superposed on each other emits light.

In a case of adhering the chart for light emission, of a thin line, or in a case of adhering the dot-shaped chart for light emission, the gap of about 0.2-0.3 mm, between the first electrode 12a and the second electrode 12b which are next to each other is preferable, and the widths of the first electrode 12a and the second electrode 12b themselves, of about 0.2-0.5 mm, are preferable for the above-described reason.

D. Variations of EL Light Emitting Device

1. Variation 1 of EL Light Emitting Device

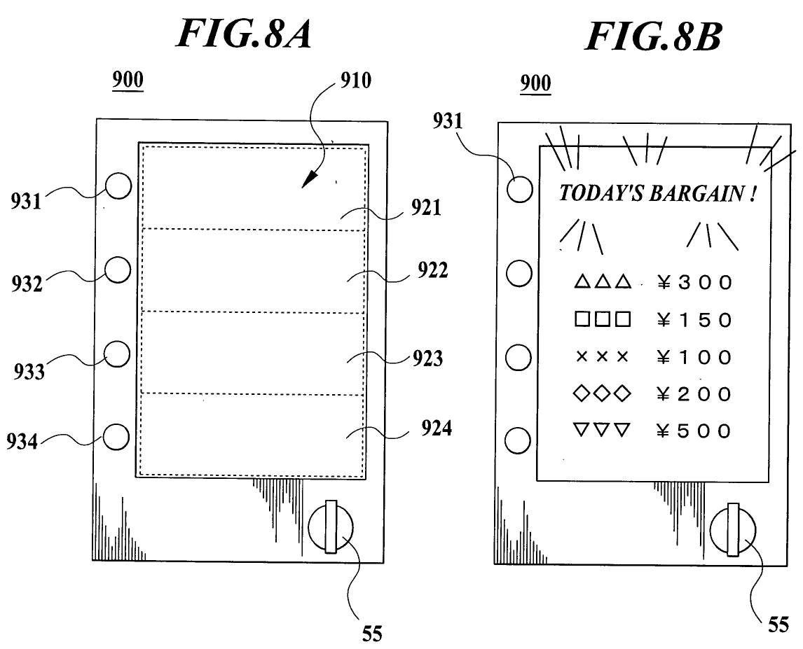

A signboard 900 according to a variation of the EL light emitting device is shown in FIGS. 8A and 8B. The signboard 900 is provided with an EL light emitting sheet 910 therein. The EL light emitting sheet 910 includes rectilinearly arranged four EL light emitting sheets that are the same sheet as the EL light emitting sheet 10. Buttons 931, 932, 933 and 934 (hereinafter referred to as buttons 930 comprehensively) corresponding to each of the electrode pairs 921, 922, 923 and 924 (hereinafter referred to as electrode pairs 920 comprehensively) are arranged on one side of a drawing screen, i.e., the top surface of the top coating layer of the EL light emitting sheet. The EL light emitting sheet 910 and the signboard 900 have the same configuration as those of the EL light emitting sheet 10 or the drawing board 50 except the arrangement configuration of the electrode pairs. The buttons 930 are made to be toggle switches. The buttons 930 are configured to output pushed signals when the buttons 930 are pushed down.

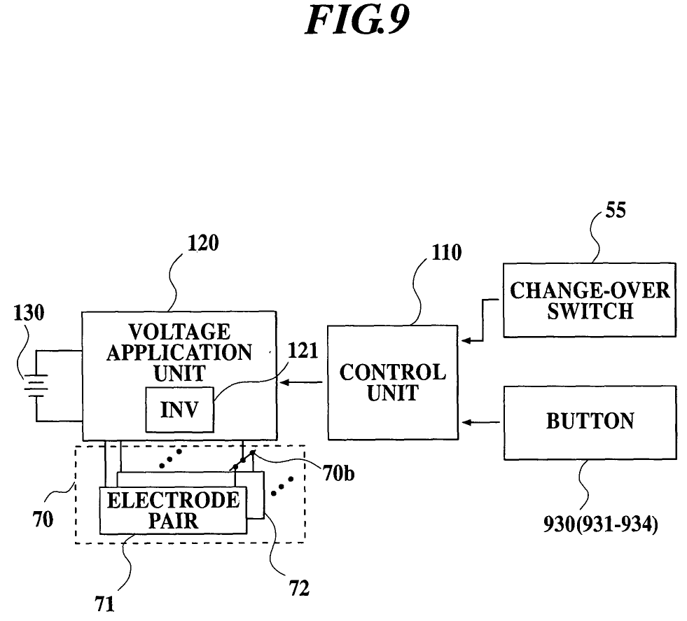

FIG. 9 is a control block diagram of the signboard 900. The configuration of the signboard is substantially the same as that of the drawing board 50 shown in FIG. 3. The configuration of the signboard is provided with the buttons 930. In FIG. 9, the control unit 110 selects and decides a region where light is to be emitted, that is, an electrode pair to which a predetermined voltage is applied on the basis of the pushed signal inputted from the buttons 930. For example, when the buttons 931 and 932 are pushed down, the control unit 110 selects and decides the electrode pairs 921 and 922. Then, the control unit 110 performs voltage application to the selected and decided electrode pairs 921 and 922 on the basis of the light emitting mode selected with the change-over switch 55.

FIG. 8B is a view showing an embodiment of the signboard 900 in the state in which the button 931 is pushed down. Since the electrode pair 921 is in the state of closed circuit formation possible state, the portion of the characters indicating “TODAY'S BARGAIN!”, which have been drawn with the electrically conductive material 30, emits light in the drawing region where the electrode pair 921 is arranged.

The buttons 930 may be composed of change-over switches to make it possible to select light emitting modes in addition to the turning on and off, of the electrode pairs. In this case, for example, a light emitting-form in which light emission is blinked in the region as “TODAY'S BARGAIN!” while a continuous light emission is given in the other region, can be realized in FIG. 8B.

E. Other Variations of the Present Invention

(1) It is preferable to contain organic or inorganic colored pigment in the waterproof layer 13 of the EL light emitting sheet, to make the electrode pattern invisible from the front side by coloring. Such coloring enables not only making the electrode pattern invisible from the front side but also widening the range of choice for design from the front side. In a case of providing the light-reflecting layer 16, it is required to arrange the light-reflecting layer 16 near the EL light-emitting layer 14 in comparison with the waterproof layer 13.

(2) It is preferable to form the light-reflecting layer 16, the EL light-emitting layer 14 and the top coating layer 15 using a binder that is similar to the material for forming the waterproof layer 13 so as to increase adhesiveness among the layers.

First Embodiment

The EL light-emitting sheet is configured by forming the waterproof layer (undercoat layer), the light-reflecting layer (dielectric layer), the EL light-emitting layer and the top coating layer on an aluminum deposition pattern which is formed on PET (piezoelectric). Each of the layers is formed by the silkscreen printing.

The polyester-based ink EX-2211 Clear E01 (made by MINO Group Co., LTD.) is used for the waterproof layer. The polyester-based ink is diluted with a ketone-based solvent to be ink for the silkscreen printing. The ink is used to form the waterproof layer by the silkscreen printing to be dried.

The light-reflecting layer comprises the barium titanate and the fluorocarbon resin that are diluted with a solvent to be ink for the silkscreen printing. The light-reflecting layer is formed by the silkscreen printing.

The EL light-emitting layer comprises the EL light-emitting elements and the fluorocarbon resin, which are diluted to be ink for the silkscreen printing. Further, silicon-based coupling agent A-187 (made by Nippon Unicar Co., Ltd.) of 0.5% by weight of the mixed solution is added, and the EL light-emitting layer is formed by the silkscreen printing.

The urethane-based ink SG460 (made by SEIKO ADVANCE Ltd.) and the H Curing Agent (made by SEIKO ADVANCE Ltd.) are mixed in a 7:8 ratio. The solution is diluted with a solvent to be ink for forming the top coating layer by the silkscreen printing. Further, the silicon-based coupling agent of 0.5% by weight of the mixed solution is added. The top coating layer is formed by the silkscreen printing and dried to harden the ink.

In the EL light-emitting sheet made by this method, since the silicon-based coupling agent is added to the EL light-emitting layer and the top coating layer, the luminance increases about 1.6 times as much as the luminance of an EL light-emitting sheet with no silicon-based coupling agent. Further, when the silicon-based coupling agent is added 0.3% by weight of the mixed solution, the luminance increases by about 30% compared to an EL light-emitting sheet with no silicon-based coupling agent.

In addition, since the silicon-based coupling agent is added to both of the EL light-emitting layer and the top coating layer, adhesiveness between the layers increases.

Second Embodiment

In the ink used for the top coating layer, the ratio of the urethane-based ink and the H Curing Agent is changed to 4:3, and the top coating layer is formed by the silkscreen printing and dried. The method of lamination up to the EL light-emitting layer is carried out by the method same as the above-described one.

In the EL light-emitting sheet made by this method, adhesiveness of the ink to material increases in comparison with the EL light-emitting sheet that is made in the first embodiment.

Third Embodiment

In the first embodiment, the hardening accelerator CARE 101 (made by SEIKO ADVANCE Ltd.) of 2-3% by weight of, the urethane-based ink SG460 (made by SEIKO ADVANCE Ltd.) and the H Curing Agent (made by SEIKO ADVANCE Ltd.) is added, which is used for the silkscreen printing to form the top coating layer. In this case, the silicon-based coupling agent is added approximately 0.5%. Also, the main component (80-90%) of the hardening accelerator is xylene, and a heat curing is adopted for curing.

In the EL light-emitting sheet made by this method, the luminance increases by 5-10% in comparison with the EL light-emitting sheet that is made in the first embodiment. The luminance is affected by a solvent, however, the solvent is volatile so that the solvent is resinified sooner by the hardening accelerator and the EL light-emitting sheet is layered before the volatile solvent evaporates a lot. Thus, the luminance is expected to improve.

The entire disclosure of Japanese Patent Application No. Tokugan 2002-254617 which was filed on Aug. 30, 2002 and Japanese Patent Application No. Tokugan 2003-122723 which was filed on Apr. 25, 2003, including specification, claims, drawings and summary are incorporated herein by reference in its entirety.

What is claimed is:

1. An electroluminescence light emitting device comprising:
an electroluminescence light-emitting layer containing electroluminescence light-emitting elements therein;
an electrode section comprising first and second electrodes which are disposed on one surface side of the electroluminescence light-emitting layer and have a predetermined pattern in which the first and second electrodes are electrically separated from each other with a spacing region;
a top coating layer, which is disposed on the other surface side of the electroluminescence light-emitting layer, and on a front surface of which an electrically conductive material is attachable to form an alternating current electric field in the electroluminescence light-emitting layer by an alternating current power supply voltage applied between the first and second electrodes, the top coating layer comprising a compound additive containing dielectric; and
a waterproof layer which is provided between the electrode section and the electroluminescence light-emitting layer.

2. The electroluminescence light emitting device as claimed in claim 1, wherein the electroluminescence light-emitting layer contains a compound additive containing dielectric.

3. The electroluminescence light emitting device as claimed in claim 1, wherein the electroluminescence light emitting layer is formed with using ink which contains the electroluminescence light-emitting elements and a fluorocarbon resin by a silkscreen printing.

4. The electroluminescence light emitting device as claimed in claim 1, wherein a light-reflecting layer is provided between the electrode section and the electroluminescence light-emitting layer.

5. The electroluminescence light emitting device as claimed in claim 4, wherein the light-reflecting layer is formed with using ink which contains a barium titanate and a fluorocarbon resin by the silkscreen printing.

6. The electroluminescence light emitting device as claimed in claim 1, wherein the compound additive containing the dielectric is a silicon-based compound.

7. The electroluminescence light emitting device as claimed in claim 6, wherein the silicon-based compound is a silicon-based coupling agent.

8. The electroluminescence light emitting device as claimed in claim 7, wherein the silicon-based coupling agent is added 0.05-5.0% by weight of a solution which is made by diluting a material for forming a layer with a solvent.

9. The electroluminescence light emitting device as claimed in claim 1, wherein the waterproof layer is formed with using polyester-based ink by the silkscreen printing.

10. The electroluminescence light emitting device as claimed in claim 1, wherein the top coating layer is formed with using ink which contains an urethane-based ink and a curing agent by the silkscreen printing.

11. The electroluminescence light emitting device as claimed in claim 10, wherein the urethane-based ink and the curing agent are mixed in a 7:8 ratio.

12. The electroluminescence light emitting device as claimed in claim 10, wherein the urethane-based ink and the curing agent are mixed in a 4:3 ratio.

13. A method for manufacturing an electroluminescence light emitting device comprising: an electroluminescence light-emitting layer containing electroluminescence light-emitting elements therein; an electrode section comprising first and second electrodes which are disposed on one surface side of the electroluminescence light-emitting layer and have a predetermined pattern in which the first and second electrodes are electrically separated from each other with a spacing region; a top coating layer, which is disposed on the other surface side of the electroluminescence light-emitting layer, and on a front surface of which an electrically conductive material is attachable to form an alternating current electric field in the electroluminescence light-emitting layer by an alternating current power supply voltage applied between the first and second electrodes; and a waterproof layer which is provided between the electrode section and the electroluminescence light-emitting layer, the method comprising the steps of:
adding a compound additive-containing dielectric in the top coating layer; and
forming the waterproof layer with using polyester-based ink by the silkscreen printing.

14. The method for manufacturing the electroluminescence light emitting device as claimed in claim 13, further comprising a step of adding a compound additive containing dielectric in the electroluminescence light-emitting layer.

15. The method for manufacturing the electroluminescence light emitting device as claimed in claim 13, further comprising a step of forming the electroluminescence light emitting layer with using ink which contains the electroluminescence light-emitting elements and a fluorocarbon resin by the silkscreen printing.

16. The method for manufacturing the electroluminescence light emitting device as claimed in claim 13, further comprising steps of forming a light-reflecting layer with using ink which contains a barium titanate and a fluorocarbon resin by the silkscreen printing, and providing the light-reflecting layer under the electroluminescence light-emitting layer.

17. The method for manufacturing the electroluminescence light emitting device as claimed in claim 13, further comprising a step of forming the top coating layer with using ink which contains an urethane-based ink and a curing agent by the silkscreen printing.

18. The method for manufacturing the electroluminescence light emitting device as claimed in claim 17, further comprising a step of adding a hardening accelerator for forming the top coating layer.
